(19) United States
(12) Patent Application Publication
(10) Pub. No.: US 2018/0263237 A1
(43) Pub. Date: Sep. 20, 2018

(54) AQUATIC MAMMAL DETERRENT SYSTEM AND METHOD

(71) Applicant: Jackie Bouler, Thomasville, AL (US)

(72) Inventor: Jackie Bouler, Thomasville, AL (US)

(21) Appl. No.: 15/459,534

(22) Filed: Mar. 15, 2017

(51) Int. Cl. A01M 29/16; H04R 1/44; H02J 7/35; H02S 10/20

(52) U.S. Cl. CPC A01M 29/16; H02S 10/20; H02J 7/35; H04R 1/44

(57) ABSTRACT

A system and method of repelling aquatic mammals from an area of water are provided. The system utilizes a speaker to transmit the sounds of predators into the area of water to repel mammals from the area and to deter mammals from returning to the area. The system includes a timer module programmed to repetitively transmit predator sounds on a time delay. By utilizing periodic intervals of predator sounds, the system and method prevent mammals from becoming conditioned to the predator sounds, thereby maintaining the effectiveness of the system over a prolonged period of time.

### FIELD OF THE DISCLOSURE

The present invention refers generally to a system and method for repelling aquatic mammals from an area of water.

### BACKGROUND

In ponds and lakes used for recreational fishing, a major problem may occur if certain types of aquatic mammals, such as otters, are introduced into the body of water. Otters can decimate a fish population of a body of water, particularly small lakes or ponds used for recreational fishing. If an owner of a lake has stocked the lake with fish for recreational fishing, a substantial loss of fish stock may represent a significant financial loss to the owner, as well as inconvenience.

Currently employed methods of keeping otters out of recreational fishing lakes may include fencing and traps. However, fencing must surround the entire lake and thus may be extremely costly. In addition, a fence for excluding otters should typically be buried at least one foot in the ground. Utilizing an electric fence may also be beneficial, but may cause harm to other wildlife or to humans. Similarly, traps for trapping otters do not work consistently and must be checked regularly, which is time consuming and inconvenient to the owner of the lake.

Other methods for keeping otters out of recreational fishing lakes include deterrence systems used to scare otters away by utilizing certain types of stimuli such as sound or lights. Acoustic deterrence systems may utilize various sounds, which may include sounds made by predators of the otter or sounds intended to cause irritation, discomfort, or even pain to the otters in order to deter the otters from entering the lake. Known methods utilizing an acoustic deterrent often work for a period of time, but the effectiveness of such systems typically declines after prolonged use. For instance, in systems utilizing predator sounds, the otters may eventually learn that there are no predators in the area and ignore the sounds in favor of hunting fish in the lake.

Accordingly, there is a need in the art for a system and method for repelling otters or other aquatic mammals from an area of water that continues to work over a prolonged period of use. Moreover, there is a need in the art for a system and method for repelling otter or other aquatic mammals that is cost effective and simple to install and operate.

### SUMMARY

A system and a method for repelling aquatic mammals from an area of water are provided. In a preferred embodiment, the system and method utilize recorded sounds of orcas, also known as killer whales. These sounds preferably include recorded echolocation clicks produced by orcas when hunting prey. The method utilizes a repetitive sequence of predator sounds transmitted into the area of water. The sequence includes a period of sound in which the predator sounds are transmitted into the water followed by a period of silence in which no sounds are transmitted into the water. The period of silence is substantially longer than the period of sound, which prevents otters or other aquatic mammals from becoming conditioned to the predator sounds. Thus, the present system and method maintain effectiveness in repelling aquatic mammals over prolonged periods of time, and may be effective for an indefinite period of time.

In one aspect, the system may be a self-contained system installed in a lake or similar body of water for repelling otters or other aquatic mammals from the lake. The system may comprise a power source for powering system electronics, a speaker for transmitting predator sounds into an area of water, and a timer module configured such that the speaker repetitively transmits predator sounds into the area of water for a period of time followed by a period of silence that is substantially longer than the period of time in which the predator sounds are transmitted. This time delay prevents aquatic mammals from becoming conditioned to the predator sounds over prolonged periods of time. In one embodiment, the period of silence lasts at least 10 times longer than the period of time in which predator sounds are transmitted. Each period of transmitting predator sounds preferably lasts at least 10 seconds, and each period of silence preferably lasts at least 10 minutes. In another preferred embodiment, a repetitive sequence of predator sounds is transmitted into the area of water, wherein the sequence comprises a period of sound lasting less then one minute followed by a period of silence lasting at least 15 minutes. The period of silence preferably lasts no longer than 45 minutes and more preferably about 20 to 30 minutes.

The system preferably comprises a post, which can be driven into the water bottom and extends above the water surface so that the system can be installed in any location in the body of water. The system preferably further comprises a solar panel mounted on the top of the post for recharging a battery for powering the system. The solar panel allows the system to be self-contained and located in a central area of the water body without the need for running electrical cables to the system from a land-based power supply. An electronic circuit module may be attached to the post above the surface of the water with the speaker electrically connected to the electronic circuit module. The speaker may float on the surface of the water or may be disposed below the surface.

The foregoing summary has outlined some features of the device, system and methods of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the device and methods disclosed herein. Those skilled in the pertinent art should also realize that such equivalent designs or modifications do not depart from the scope of the device and methods of the present disclosure.

### DESCRIPTION OF DRAWINGS

These and other features, aspects, and advantages of the present disclosure will become better understood with regard to the following description, appended claims, and accompanying drawings where:

FIG. 1 shows a perspective view of a system embodying features consistent with the present disclosure, wherein the system is installed in a body of water.

FIG. 2 shows a partial view of electrical components of a system embodying features consistent with the present disclosure, including a circuitry unit and a battery.

FIG. 3 shows a schematic diagram of a system embodying features consistent with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As used herein, the term “speaker” refers to a loudspeaker for converting an electrical audio signal into a corresponding sound.

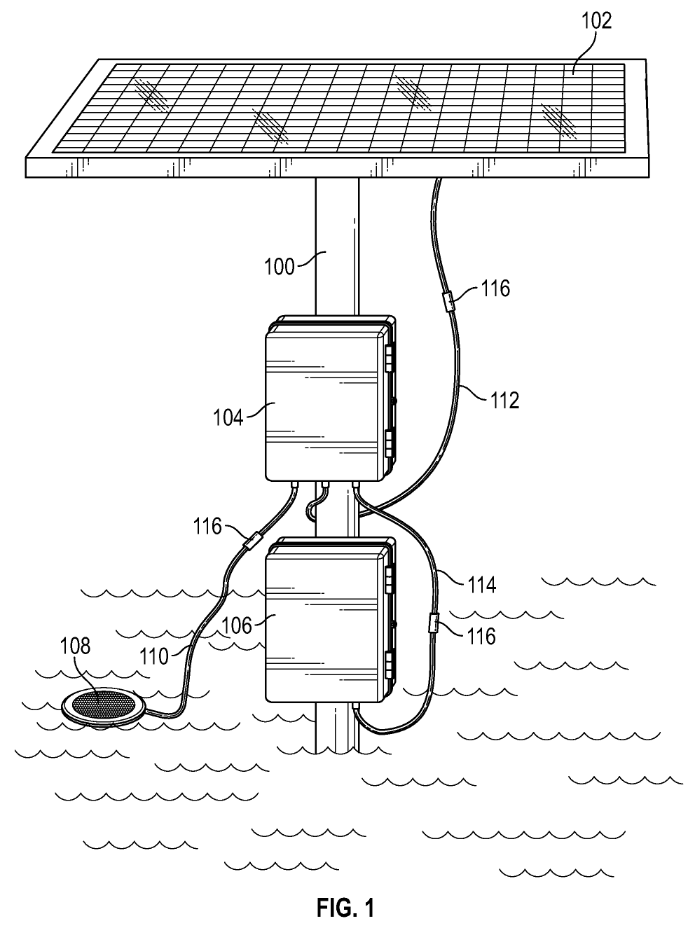

Turning now to the drawings, FIGS. 1-3 illustrate preferred embodiments of a system for repelling otters or other aquatic mammals, which may include sea otters, freshwater otters, such as the North American river otter, minks, muskrats, seals, sea lions, or other aquatic or semiaquatic mammals. The system transmits sounds of predators of aquatic mammals into an area of water in order to repel the mammals from the area to prevent the mammals from killing fish or other aquatic species in the water body. In a preferred embodiment, the system utilizes recorded sounds of orcas, and preferably sounds made by orcas when hunting prey. The sounds preferably include recorded sounds of echolocation clicks produced by orcas when hunting prey. Other orca sounds utilized may include whistles, pulsed calls, low-frequency pops, or jaw claps. The system is particularly effective in repelling freshwater otters from relatively small ponds or lakes used for recreational fishing. Although orcas are not natural predators of the freshwater otter, Applicant has found the sound of orcas to be effective in repelling freshwater otters as well as sea mammals. Freshwater otters are relatives of sea otters and appear to have a natural instinct to flea an area upon hearing sounds produced by orcas.

In order to prevent otters from becoming conditioned to the predator sounds, the system generates a repetitive sequence of sounds followed by extended periods of silence. The sequence comprises a period of sound in which predator sounds are transmitted into an area of water from which otters are to be repelled followed by a period of silence in which no predator sounds are transmitted into the water. The period of silence is substantially longer than the period of sound such that the otters do not become conditioned to the predator sounds. Thus, the present system maintains its effectiveness in repelling otters over prolonged periods of time.

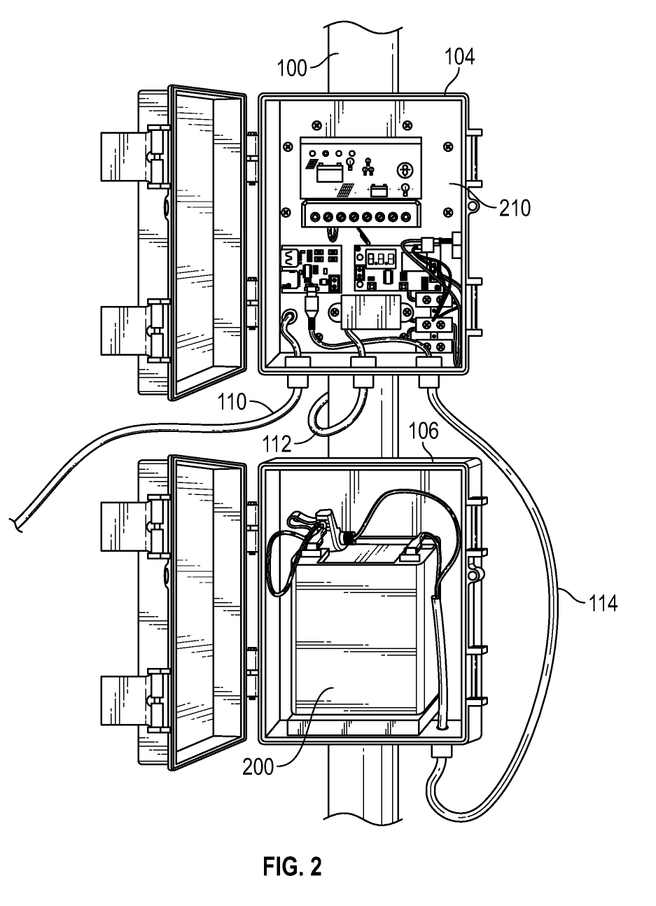

FIG. 1 illustrates the system installed in a lake that may provide habitat for wild otters or other aquatic mammals. As shown, the system may be a self-contained system that includes a power source for powering system electronics. The power source is preferably a battery 200, as shown in FIG. 2, which is preferably contained within a housing 106. In a preferred embodiment, the system comprises a post 100, which can be driven into the water bottom such that the post 100 extends above the water surface, as shown in FIG. 1. Thus, the system can be installed in any location in the lake or other water body. Mounting the system on a post 100 also provides a moveable system that may be moved to different locations within a lake or to a different body of water, if desired. The post 100 may be a standard 2⅜″ fence post. The system preferably further comprises a solar panel module 102 mounted on the top of the post 100 for recharging the battery 200. The solar panel module 102 allows the system to be self-contained and installed in any portion of the lake without the need for running electrical cables to the system from a land-based power supply. The solar panel module 102 comprises a plurality of solar cells and recharges the battery 200 during daylight hours so that the system can continue working during nighttime hours or during periods of low sunlight. The battery 200 is preferably capable of powering the system for at least one week before requiring recharging. The solar panel module 102 is electrically connected to the electronic circuit module 210 via a waterproof cable 112.

As shown in FIG. 2, the system further comprises an electronic circuit module 210, which is preferably contained within a housing 104 attached to the post 100 above the surface of the water. Both housings 104 and 106 preferably have a waterproof seal when closed to prevent the battery 200 and the electronic circuit module 210 from exposure to significant amounts of moisture. Both housings 104 and 106 preferably also have Styrofoam or a similar type of insulating material installed therein in order to provide insulation for the battery 200 and the electronic circuit module 210. The electronic circuit module 210 is electrically connected to the battery 200 via a waterproof cable 114 and is powered by the battery 200.

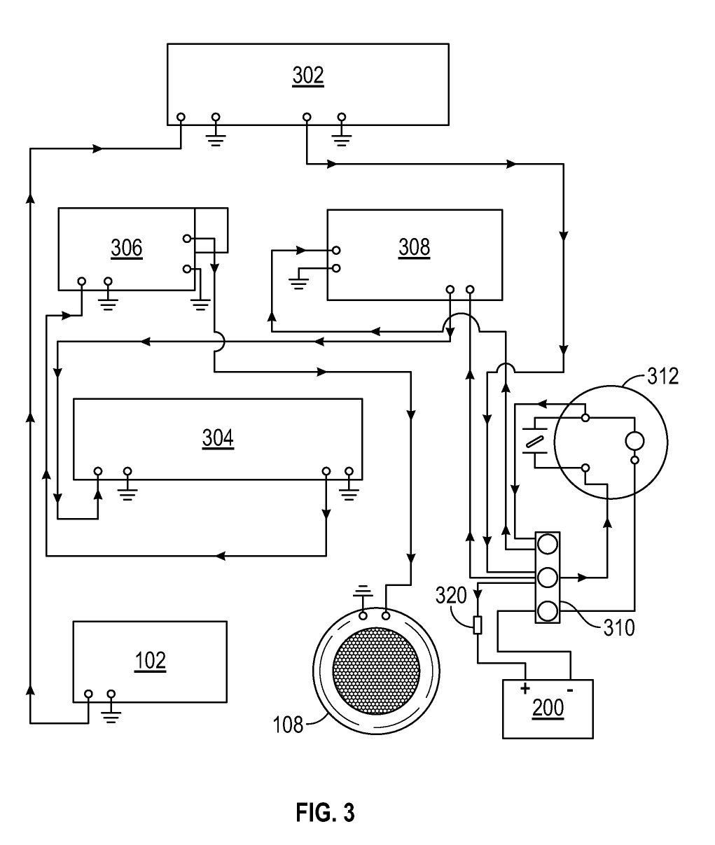

The system further comprises at least one acoustic transducer configured for transmitting sound into the area of water. The acoustic transducer may be mounted on a suitable structure submersed in the water. In a preferred embodiment, as shown in FIGS. 1 and 3, the system comprises a waterproof speaker assembly 108 that includes the at least one acoustic transducer. The speaker 108 is disposed at least partially under the surface of the water. The speaker 108 may be a floating speaker 108, as shown in FIG. 1, in which the speaker outputs sound waves downward into the water, or the speaker 108 may be mounted to a structure submersed in the water. Multiple acoustic transducers or speaker assemblies may optionally be utilized. Multiple acoustic transducers or speaker assemblies may be spaced apart in the body of water in order to optimize the effect of repelling aquatic mammals. The speaker 108 is electrically connected to the electronic circuit module 210 via a waterproof cable 110, which is preferably a 25-foot PVC power cable. The waterproof cables 110, 112, 114 may have waterproof plugs, which may be two pin, three pin, or four pin plugs, for ease of connecting and disconnecting components of the system.

FIG. 3 illustrates a schematic diagram of the system including submodules of the electronic circuit module 210, which includes a timer module 308. The submodules may further include a solar charge controller module 302, a voltage converter module 304, and a sound card module 306. The system may further comprise a solar panel module 102, a battery 200, an on/off switch 312, and a wire junction 310 for routing power to different components of the system. In a preferred embodiment, the solar panel module 102 is a single function 30 watt, 12 volt solar panel module. The solar charge controller module 302 has an input from the solar panel module 102 and an output for charging the battery 200. The solar charge controller module 302 regulates the battery 200 voltage in order to protect the battery from being overcharged. The battery 200 is preferably a 12 volt, 5 amp battery. The solar charge controller module 302 preferably has a maximum power voltage of 17.5 volts and may regulate the voltage down for charging the 12 volt battery 200. The system preferably comprises a fuse 320 to provide overcurrent protection for the battery 200.

The electronic circuit module 210 preferably includes an on/off switch 312 for supplying power to the system and for turning off power to the system. The switch 312 preferably has a built-in LED light, which indicates to the user when the switch is on or off. An LED light may also indicate to the user battery 200 charging status and/or battery capacity.

As shown in FIG. 3, the electronic circuit module 210 comprises a timer module 308. The timer module 308 is coupled to the speaker 200 and is configured such that the speaker 200 repetitively transmits predator sounds into the water for a period of time followed by a period of silence. The timer module 308 is programmed to cycle through periods of being activated during periods of transmitting predator sounds and periods of being inactivated during periods of silence in which no predator sounds are transmitted. The input power to the timer module 308 may include a built-in relay with an input and an output. In a preferred embodiment, the electronic circuit module 210 further comprises a sound card module 306 and a voltage converter module 304. The voltage converter module 304 preferably has a 12 volt input and a 5 volt output. The sound card module 306 preferably has a 5 volt input and has an audio output to the speaker 108. The voltage converter module 304 regulates the voltage down from 12 volts to 5 volts for the sound card module 306. The sound card module 306 may be programmed to output audio at a predetermined volume. The sound card module 306 may have a built-in card having recorded predator sounds, such as those of orcas, stored thereon. The sound card module 306 outputs these sounds to the speaker 108 to transmit predator sounds into the water based on a timing sequence programmed into the timer module 308. The timer module 308 may be reprogrammable to adjust of the timing sequence. The timer module 308 may also have finite and infinite loop timing modes for controlling the time of operation of the system.

In alternative embodiments, recorded predator sounds may be stored on any suitable media, such as an audiocassette or any suitable magnetic or laser read/write media.

Once the system is installed in a body of water and activated for use, the timer module 308 is programmed to repetitively transmit predator sounds into an area of water according to a predetermined sound sequence. The sequence includes a period of time in which predator sounds are transmitted into the water followed by a period of silence in which no sounds are transmitted by the system. The period of silence lasts at least 10 times longer than the period of time in which predator sounds are transmitted. Each period of transmitting sounds preferably lasts at least 10 seconds, and each period of silence preferably lasts at least 10 minutes. This timing provides a substantial time delay, which may be adjusted by reprogramming the timer module 308, between relatively short periods of predator sounds being transmitted into the area of water. This substantial time delay, during which no sounds are transmitted, prevents otters or other aquatic mammals from becoming conditioned to predator sounds and thus provides a system that may repel aquatic mammals from a body of water for an indefinite period of time.

In a preferred embodiment, the sound sequence includes a period of predator sounds lasting less than one minute followed by a period of silence lasting at least 15 minutes. The period of silence preferably lasts no longer than 45 minutes and more preferably about 20 to 30 minutes. In a more preferred embodiment, predator sounds are continuously transmitted into the area of water for a period of about 20 to 40 seconds with a time delay of about 20 to 25 minutes between predator sounds being repeated. The predator sound sequence may continue indefinitely as the battery 200 is recharged by the solar panel module 102. Alternatively, the system may be activated for specific periods of time each day and deactivated for other periods of time in the day. For instance, the system may be activated during daylight hours and deactivated at night.

While the system is activated, the system repeats the predator sounds after each time delay in order to repel aquatic mammals that may have newly entered the area of water or aquatic mammals that may have returned after previously entering the area of water. Returning animals that reenter the area during a time delay may perceive the threat of predators to be eliminated. However, the sounds of predators repeated after the time delay will cause the animals to leave the area again. Because animals initially entering or returning to the area of water are likely to do so during a time delay, the predator sound sequence utilized by the system will prevent animals from becoming conditioned to the predator sounds.

The volume of the predator sounds is preferably adjusted so that aquatic mammals are able to hear the predator sounds throughout the area of water. However, the volume is preferably not loud enough to cause pain or discomfort to the animals.

It is understood that versions of the invention may come in different forms and embodiments. Additionally, it is understood that one of skill in the art would appreciate these various forms and embodiments as falling within the scope of the invention as disclosed herein.

What is claimed is:

1) A method of repelling aquatic mammals from an area of water, said method comprising:
repetitively transmitting predator sounds into the area of water for a period of time followed by a period of silence lasting at least 10 times longer than the period of time in which predator sounds are transmitted.

2) The method of claim 1, wherein the predator sounds include recorded sounds of an orca.

3) The method of claim 2, wherein the recorded sounds of an orca include the sounds of echolocation clicks.

4) A method of repelling aquatic mammals from an area of water, said method comprising:
generating a repetitive sequence of predator sounds transmitted into the area of water, said sequence comprising a period of sound lasting less than one minute followed by a period of silence lasting at least 15 minutes.

5) The method of claim 4, wherein the sequence comprises a period of sound lasting 20 to 40 seconds followed by a period of silence lasting at least 15 minutes.

6) The method of claim 4, wherein the predator sounds include recorded sounds of an orca.

7) The method of claim 6, wherein the recorded sounds of an orca include the sounds of echolocation clicks.

8) A system for repelling aquatic mammas from an area of water, said system comprising:
a power source;
at least one acoustic transducer configured to transmit predator sounds into the area of water; and
a timer module coupled to the at least one acoustic transducer, wherein the timer module is configured such that the at least one acoustic transducer repetitively transmits predator sounds into the area of water for a period of time followed by a period of silence lasting at least 10 times longer than the period of time in which predator sounds are transmitted.

9) The system of claim 8, wherein the timer module is configured such that the at least one acoustic transducer repetitively transits predator sounds into the are of water for a period of time lasting less than one minute followed by a period of silence lasting at least 15 minutes.

10) The system of claim 9, wherein the timer module is configured such that the at least one acoustic transducer repetitively transits predator sounds into the are of water for a period of time lasting 20 to 40 seconds followed by a period of silence lasting at least 15 minutes

11) The system of claim 8, wherein the at least one acoustic transducer is included within a loudspeaker assembly disposed at least partially under the surface of the water.

12) The system of claim 8, wherein the power source is a battery.

13) The system of claim 12, further comprising a solar panel configured for recharging the battery.
